(19) United States
(12) Patent Application Publication
(10) Pub. No.: US 2012/0124773 A1
(43) Pub. Date: May 24, 2012

(54) MECHANISM FOR INSTALLING A DOOR OR OTHER SIMILAR CLOSURE DEVICE WITH ROTARY AND TRANSLATIONAL MOTION

(75) Inventor: Sandro Saccon, Santa Maria Di Sala (IT)

(73) Assignee: Sandra RIGO, Santa Maria Di Sala (IT)

(21) Appl. No.: 13/388,927

(22) PCT Filed: Jul. 29, 2010
(86) PCT No.: PCT/EP2010/061049

§ 371 Date: Feb. 3, 2012

(30) Foreign Application Priority Data
Aug. 3, 2009 (IT) PD2009A000232

(51) Int. Cl. E05D 3/06; E05D 7/04

(52) U.S. Cl. 16/249; 16/366

(57) ABSTRACT

A mechanism for installing a door or other similar closure device with rotary and translational motion, of the type comprising the following elements to be associated with a leaf
first pivoting means, which form a first vertical axis (11) for the pivoting of the leaf (12), in a central region thereof, to means for translational motion arranged so as to slide in a corresponding guide (13) associated with the upper stringer (14) of the frame (15) of the door;
second pivoting means, whose axis is parallel with respect to the axis of the first pivoting means, for the articulation of two arms (16, 17), a first upper arm (16) and a second lower arm (17), which are both pivoted by means of a first end (21, 22) thereof to the frame (15) of the door or window proximate to a jamb (18) so as to form a second rotation axis (20),
third pivoting means, which are formed by the second ends (23, 24) of the arms (16, 17), which are hinged to the leaf (12) so as to form a third rotation axis (26) that passes through the leaf (12) parallel to the first and second axes and in an intermediate position between the two first and second axes when the leaf is in the closed configuration.

The second pivoting means comprise a pivot (27) arranged in a compartment (28) formed within the jamb (18), the pivot (27) joining the first ends (21, 22) of the arms (16, 17) and thus causing their joint rotation.

The mechanism according to the invention facilitates and improves the installation of doors with rotary and translational motion.

The present invention relates to a mechanism for installing a door or other similar closure device with rotary and translational motion.

### BACKGROUND OF THE INVENTION

Nowadays doors that can be opened and closed by means of rotary and translational motion are widely known.

Such doors are generally installed by associating to a leaf the following elements:
first pivoting means, which form a first vertical axis for the pivoting of the leaf or the like, in a substantially central region thereof, to means for translational motion arranged so as to slide in a corresponding guide associated with at least one stringer, upper or lower, of the frame of the door or other similar closure device;
second pivoting means, whose axis is parallel with respect to the axis of such first pivoting means, for the articulation of two arms, a first upper arm and a second lower arm, which are both pivoted by means of a first end thereof to the frame of the door or window proximate to a jamb so as to form a second rotation axis, and which have their opposite ends coupled to the leaf or the like so as to form a third rotation axis, passing through the leaf in the direction of height of such leaf.

This mechanism has the distinctive characteristic that the second pivoting means are coupled to the frame with means for setting the distance of the second rotation axis from the near jamb of the door or the like. Moreover, the second ends of the arms are mutually coupled by means of a pivot that passes through the entire height of the leaf and which defines the third rotation axis.

This mechanism ensures that the thrust imposed by a user to the leaf to open the door, for example outwards, makes the leaf rotate about the first axis, such rotation involving the simultaneous rotation of the arms about the third axis in the opposite direction with respect to the leaf.

The second axis, about which both the leaf and the arms rotate, is brought into play by such arms to travel a circle arc trajectory with respect to the third axis, in the opposite direction with respect to the direction of opening of the leaf.

At the same time, the first axis makes a translational movement in parallel with itself, thanks to the translational motion means, towards the jamb where the arms are coupled.

This movement, which is granted to the leaf by the mechanism, makes it possible to reduce the volume swept with a customary opening or closing movement by means of a normal hinging of the leaf to a jamb of a door.

The movement just described brings considerable advantages when several doors are to be installed close to each other, for example in convergent walls. In such a situation, if the two doors are opened, one could inconveniently prevent the correct and complete opening of the other and vice versa.

Moreover, the leaves of doors with rotary and translational motion can generally be opened on both sides, further facilitating transit through such doors and so allowing the user to choose whether it is more convenient to open a leaf with a pushing movement or with a pulling movement.

Doors installed with such a mechanism, furthermore, are particularly adapted to be used in hospitals and in reception areas, but also in domestic areas that are frequented by persons with disabilities. Indeed, the progressive reduction of the distance between the user and the handle of the leaf makes opening the door much simpler, since the user, who may be for example sitting in a wheelchair or leaning on a crutch, does not have to lean dangerously away from his/her position of equilibrium.

The mechanism as described above is disclosed in W02007/039401 in the name of this same applicant.

Such mechanism, although highly appreciated and widespread for installing doors with rotary and translational motion, is laborious to install for a craftsman who has to mount it on a wooden door, owing to the pivot defining the third rotation axis, which has to be installed so as to pass through the leaf, therefore necessitating the drilling of a hole through such leaf for its entire height.

Moreover, the mechanism that is the subject matter of the patent referenced above also comprises means for setting the distance of the second rotation axis from the jamb.

Such setting means, despite being functional, are simple to implement but difficult to assemble, resulting for an assembler to be complex to install and awkward to adjust.

### SUMMARY OF THE INVENTION

The aim of the present invention is to provide a mechanism for installing a door or other similar closure device with rotary and translational motion that is capable of overcoming the above cited drawbacks of the equivalent known mechanism.

Within this aim, an object of the present invention is to provide a mechanism that is easier to mount on a solid leaf, for example made of solid wood, and in which the adjustment of the position of the leaf with respect to the jambs is easier.

A further object of the present invention is to provide a mechanism that can be positioned in any position with respect to the depth of the doorway in which the door is to be installed.

A further object of the present invention is to provide a mechanism that can be applied to leaves of different heights.

A further object of the present invention is to provide a mechanism that can be economically produced using known systems and technologies.

This aim, as well as these and other objects which will become better apparent hereinafter, are achieved by a mechanism for installing a door or other similar closure device with rotary and translational motion, of the type comprising the following elements to be associated with a leaf:
first pivoting means, which form a first vertical axis for the pivoting of the leaf, in a central region thereof, to means for translational motion arranged so as to slide in a corresponding guide associated with the upper stringer of the frame of the door;
second pivoting means, whose axis is parallel with respect to the axis of said first pivoting means, for the articulation of two arms, a first upper arm and a second lower arm, which are both pivoted by means of a first end thereof to the frame of the door or window proximate to a jamb so as to form a second rotation axis,
third pivoting means, which are formed by the second ends of said arms, which are hinged to the leaf so as to form a third rotation axis that passes through the leaf parallel to said first and second axes and in an intermediate position between said two first and second axes when the leaf is in the closed configuration,

said mechanism being characterized in that said second pivoting means comprise a pivot arranged in a compartment formed within the jamb, said pivot joining the first ends of said arms and causing their joint rotation.

### BRIEF DESCRIPTION OF THE DRAWINGS

Further characteristics and advantages of the invention will become better apparent from the following detailed description of a preferred, but not exclusive, embodiment thereof, illustrated by way of a non-limiting example in the accompanying drawings, wherein:

FIG. 1 is a perspective view from below of a door provided with a mechanism according to the invention;

FIG. 2 is a perspective overall exploded view of a mechanism according to the invention;

FIG. 3 is a perspective exploded view of the upper part of the mechanism according to the invention;

FIG. 4 is a perspective exploded view of the lower part of the mechanism according to the invention;

FIG. 5 is a perspective exploded view of a detail of the lower part of FIG. 4;

FIG. 6 is a front sectional view of the detail of FIG. 5, assembled;

FIG. 7 is a top sectional view of the detail of FIGS. 5 and 6;

FIG. 8 is a schematic top view of the mechanism in a first type of mounting;

FIG. 9 is a schematic top view of the mechanism in a second type of mounting.

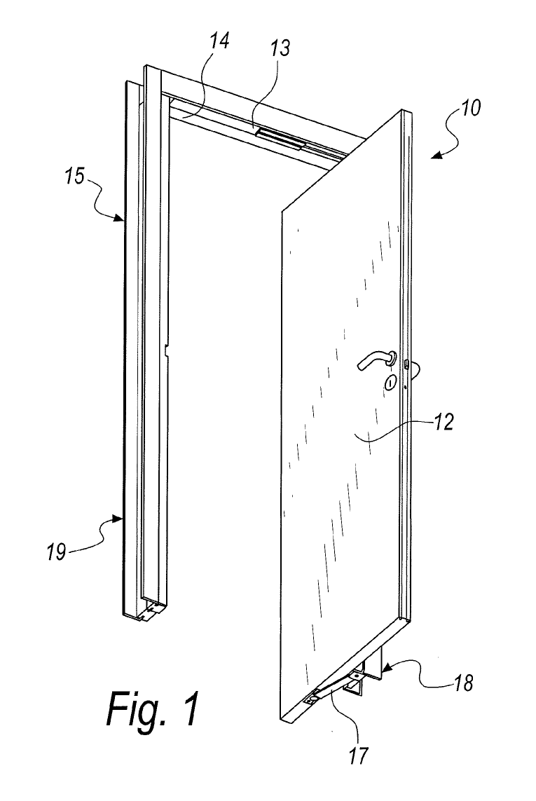

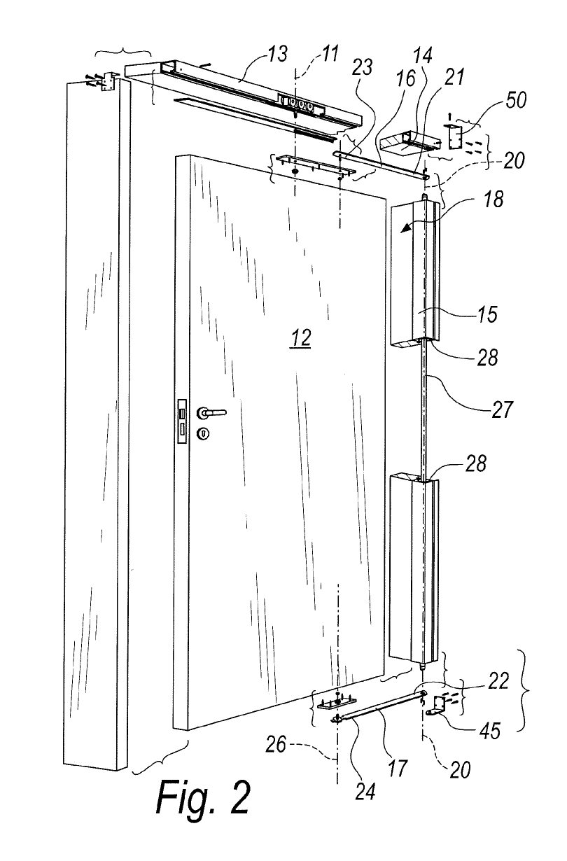

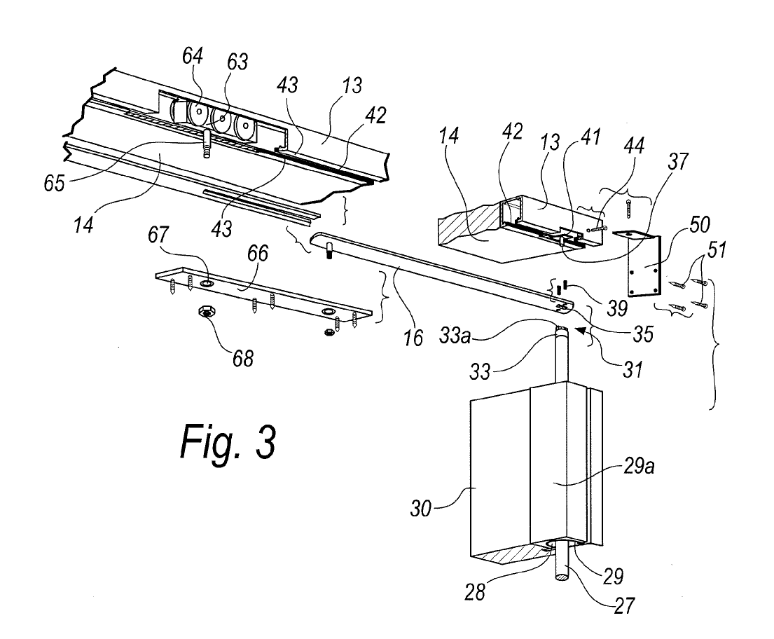

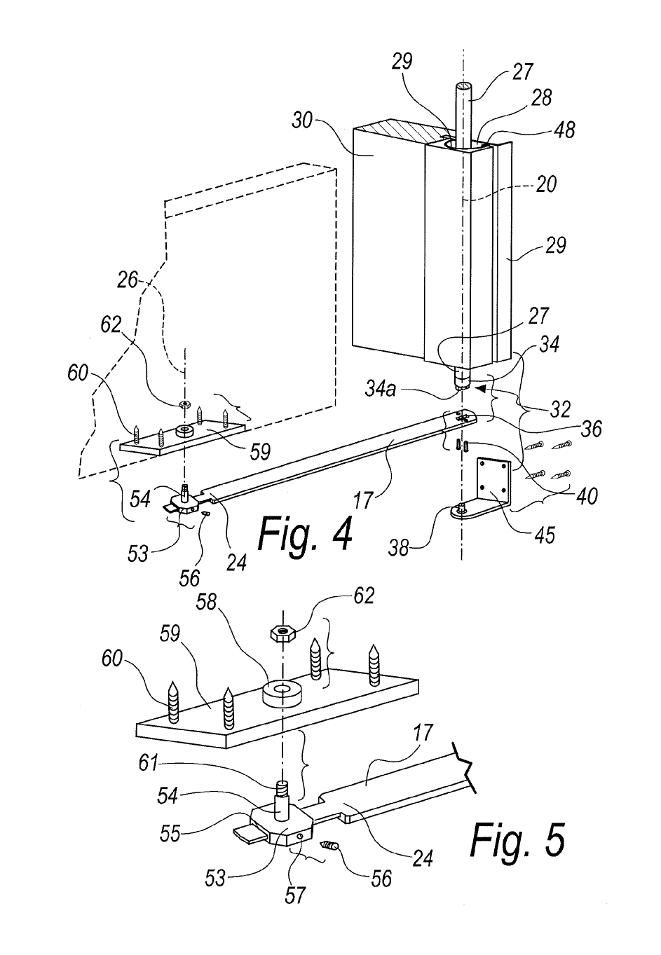

### DESCRIPTION OF THE PREFERRED EMBODIMENTS

With reference to the figures, a door provided with the mechanism according to the invention is generally designated by the reference numeral 10.

The mechanism, applied to the door 10 by way of a non-limiting example of the invention, comprises the following elements to be associated with a leaf 12 and to a frame 15 that surrounds it:
first pivoting means, which form a first vertical axis 11 for the pivoting of the leaf 12, in a central region thereof, to means for translational motion arranged so as to slide in a corresponding guide 13 associated with an upper stringer 14 of the frame 15 of the door 10;
second pivoting means, whose axis is parallel with respect to the axis of such first pivoting means, for the articulation of two arms, a first upper arm 16 and a second lower arm 17, which are both pivoted by means of a first end thereof, respectively 21 and 22, to the frame 15 proximate to a first jamb 18, such first pivoting means forming a second rotation axis 20,
third pivoting means, which are formed by second ends, 23 and 24 respectively, of the arms 16 and 17, the second ends 23 and 24 being hinged to the leaf 12 so as to form a third rotation axis 26 that passes through the leaf 12 parallel to the first axis 11 and the second axis 20, and in an intermediate position between the first axis 11 and the second axis 20 when the leaf 12 is in the closed configuration.

The second pivoting means comprise a pivot 27 arranged in a compartment 28 formed within the jamb 18.

The pivot 27 joins the first ends 21 and 22 of the arms 16 and 17, thus causing their joint rotation.

The pivot 27 is constituted by a tubular profile having a circular cross section.

The frame 15 is assumed to be composed of two jambs 18 and 19, which are vertical, and of the upper stringer 14.

The second pivoting means also comprise, in addition to the pivot 27, a profile 29 that forms the compartment 28 and which contains the pivot 27, and which is adapted to be incorporated into the jamb 18, together with a member 30 to be placed alongside it so as to complete the jamb 18.

The profile 29 is an extruded element made of metal, or plastics, or wood.

The profile 29, if it is not made of wood, is covered with a covering profile 29a, which is contoured so as to conceal it from view when the casement is finished.

In the embodiment described herein, the means for fixing the pivot 27 in the compartment 28 comprise, for fixing to the upper arm 16 and to the lower arm 17, a corresponding rigid connection device, 31 and 32 respectively, adapted to provide a non-welded join between the pivot 27 and the corresponding arm.

The rigid connection device 31 and 32 comprises a head, 33 and 34 respectively, that is contoured so as to be inserted in the corresponding end port of the pivot 27; the head 33 and 34 has an axial protrusion, 33a and 34a respectively, that is contoured to pass through a complementarily shaped opening 35 and 36, which is formed respectively on the first end 21 of the upper arm 16 and on the first end 22 of the lower arm 17.

The protrusion 33a and 34a is contoured so as to have a central hole for engagement with a corresponding second pivot 37 and 38, described in more detail hereinbelow, in order to define the second rotation axis 20, and two radial expansions that prevent relative rotation between the tubular pivot 27 and the arm 16 and 17.

Two screws 39 and 40 determine the fixing between the arms 16 and 17 and the corresponding head 33 and 34.

Such rigid connection device enables an installer to adapt the pivot 27 to the height of the leaf 12 in which it is to be inserted.

The pivot 27 supplied to the installer is of standard length and is trimmed to the required length by sawing, and subsequently it is fixed to the arms 16 and 17 by means of the devices 31 and 32.

The devices 31 and 32 ensure a stable connection between the two components, preventing the installer from resorting to welding operations, which are expensive and difficult and which carry the risk of deforming and tensioning such components.

The second upper pivot 37 protrudes from a plate 41, two opposing lateral portions thereof being adapted to be inserted in the mutually facing longitudinal grooves of the guide 13, which is constituted by a profile bar that is coupled to the upper stringer 14 and which is substantially C-shaped in section, with an opening 42 facing downward.

The longitudinal grooves of the guide 13 are formed on the facing edges of folds 43 of the profile bar that is C-shaped in section.

The plate 41 is fixed in the guide 13 by means of a screw 44 that passes through corresponding open holes on the two mutually facing vertical walls of the profile bar proximate to the area where the plate 41 is inserted; the screw 44 tightens the profile bar by clamping the plate 41 between the two mutually facing folds 43 that support it.

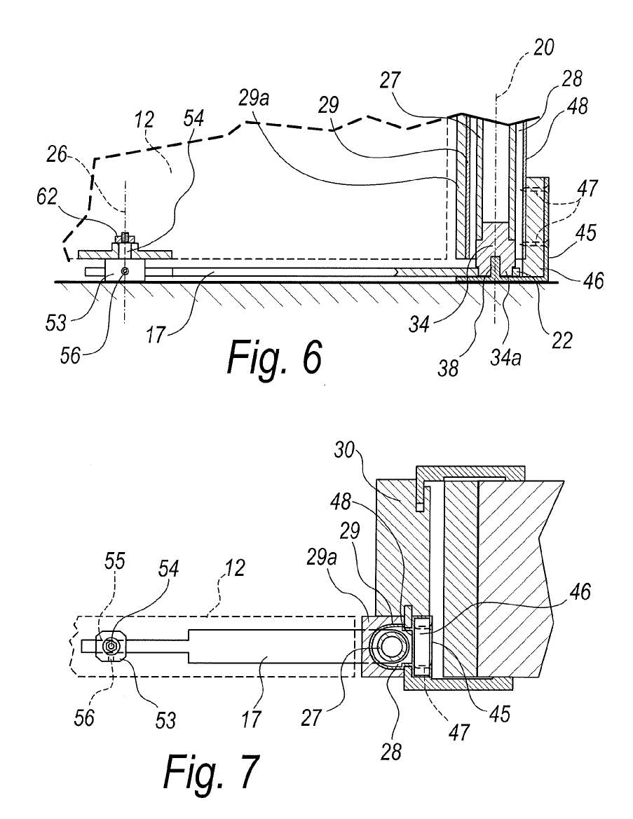

The second lower pivot 38 is supported by a bracket 45 which is L-shaped; the bracket 45 is fixed to a shim 46, shown in FIGS. 6 and 7, by means of screws 47 which engage with an internal partition 48 of the profile 29, at its lower end portion.

The guide 13 is fixed upward to the profile 29 by means of a second L-shaped bracket 50, which in turn is fixed by means of screws 51 and a similar shim, which is not shown in the figures.

The means for setting and adjusting the distance of the third rotation axis 26 from the second rotation axis 20 are constituted by a flat block 53 that supports a third pivot 54.

The flat block 53 is arranged so as to perform a translational motion at the end 24 of the second arm 17, thanks to a through opening 55 which is contoured to be crossed by the end 24 of the lower arm, which is flat.

The position of the block 53 is defined by means of screwing a fixing grub screw 56, to be screwed into a corresponding threaded hole 57 provided in one side of the block 53 until it affects the through opening 55 and abuts within it against the end 24.

The third pivot 54 is adapted to be inserted into a complementarily shaped rotation ring 58, which is joined to the leaf 12 by means of a lower plate 59 fixed to the lower edge of the leaf 12, for example by means of screws 60.

The third pivot 54 has a threaded end portion 61 that is designed to be locked to the ring 58 by means of a nut 62.

The mechanism 10 according to the invention, thanks to the pivot 27 that joins the upper arm 16 and the lower arm 17, located outside the leaf 12, as in the known art, and hidden in the profile 29 that is integrated in the jamb 18, is easier and quicker to install compared to the known art.

Moreover the means for setting and adjusting the distance between the second axis 20 and the third axis 26, as described above, make the sequence of installation and setting much simpler than with the known mechanism, in which the distance between the second and third axes cannot be modified, and the distance between the second axis and the jamb has to be modified instead.

The means for translational motion for the first pivoting means are constituted by a trolley 63 which is provided with six wheels 64, arranged so as to slide in the guide 13.

Inside the profile bar that forms the guide 13 there are four longitudinal beads, each of which defines a track for the anti-derailing and anti-sticking sliding of the trolley 63.

Of the six wheels 64, four are load-bearing and two push against upper beads 9 in order to prevent the rotation and sticking of the trolley 64.

The first pivoting means are provided by a fourth pivot 65 that protrudes from the body of the trolley 64, and which is adapted to be inserted into the facing upper edge of the leaf 12.

The fourth pivot 65 passes through a straight edge 66 that is adapted to be applied on the upper edge of the leaf 12 and which also has a hole 67 for the passage of the pivot 65.

The fourth pivot 65 is fixed to the straight edge 66 by means of an opposing nut 68, which is accommodated between the straight edge 68 and a suitable slot formed on the upper edge of the leaf 12, which is not shown for simplicity.

In practice it has been found that the invention as described achieves the intended aim and objects. In particular, with the present invention a mechanism for installing a door or other similar closure device with rotary and translational motion has been achieved which with a few, simple mechanical operations can be adapted to doors or other closure devices of various dimensions, without having to make a through hole that passes through the leaf in the direction of height of such leaf.

Moreover, with the present invention a mechanism has been provided that facilitates the setting of the position of the leaf with respect to the jambs.

Moreover, with the present invention a mechanism has been provided that can be positioned in any position with respect to the thickness of the wall in which the door is to be installed.

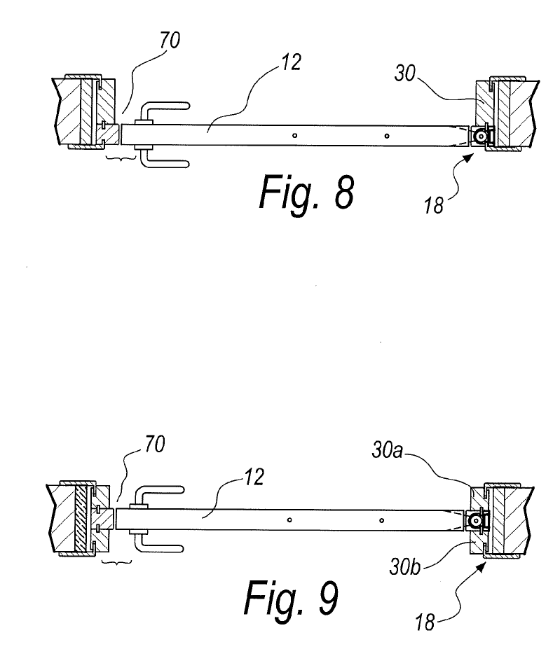

In this regard, reference is made to FIGS. 8 and 9.

FIG. 8 shows a leaf 12, seen from above, mounted with a mechanism according to the invention, proximate to an outside edge of a doorway 70 for a door.

In this case the profile 29 has a member 30 on one side only, to complete the jamb 18.

In FIG. 9 a leaf 12 is shown, seen from above, mounted with a mechanism according to the invention, in the centre of a doorway 70 for a door.

It should be noted that assemblies in intermediate positions with respect to those described above are also intended to be possible.

In this case the profile 29 has two members, 30a and 30b, one on each side, to complete the jamb 18.

With the present invention a mechanism that can be applied to leaves of different heights has been provided.

Moreover, with the present invention a mechanism has been devised that can be economically produced using known systems and technologies.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the dimensions, may be any according to requirements and to the state of the art.

The disclosures in Italian Patent Application No. PD2009A000232 from which this application claims priority are incorporated herein by reference.

Where technical features mentioned in any claim are followed by reference signs, such reference signs have been inserted for the sole purpose of increasing the intelligibility of the claims and accordingly such reference signs do not have any limiting effect on the interpretation of each element identified by way of example by such reference signs.

1-9. (canceled)

10. A mechanism for installing a door or other similar closure device with rotary and translational motion, of the type comprising the following elements to be associated with a leaf
first pivoting means, which form a first vertical axis for the pivoting of the leaf, in a central region thereof, to means for translational motion arranged so as to slide in a corresponding guide associated with the upper stringer of a frame of the door;
second pivoting means, whose axis is parallel with respect to the axis of said first pivoting means, for the articulation of two arms, a first upper arm and a second lower arm, which are both pivoted by means of a first end thereof to the frame of the door or window proximate to a jamb so as to form a second rotation axis,
third pivoting means, which are formed by the second ends of said arms, which are hinged to the leaf so as to form a third rotation axis that passes through the leaf parallel to said first and second axes and in an intermediate position between said two first and second axes when the leaf is in the closed configuration,
wherein said second pivoting means comprise a pivot arranged in a compartment formed within the jamb, said pivot joining the first ends of said arms and causing their joint rotation.

11. The mechanism according to claim 10, wherein said pivot is constituted by a tubular profile.

12. The mechanism according to claim 10, wherein said second pivoting means comprise, in addition to the pivot, also a profile which forms the compartment, contains said pivot and is designed to be built into the jamb.

13. The mechanism according to claim 12, wherein said profile is an extruded element made of metal or plastics or wood.

14. The mechanism according to claim 12, wherein said profile is covered with a covering profile, which is contoured so as to conceal it from view when the casement is finished.

15. The mechanism according to claim 10, wherein the means for fixing the pivot in the compartment are provided, which comprise, for fixing to the upper arm and to the lower arm, a corresponding rigid connection device, which comprises a head that is contoured so that it is inserted in the corresponding end port of the pivot; said head having an axial protrusion designed to pass through a complementarily shaped opening that is formed respectively on the corresponding first end of the upper arm and lower arm, said protrusion being contoured so as to have a central hole for engagement with a corresponding second pivot, in order to define the second rotation axis, and two radial expansions that prevent relative rotation between the tubular pivot and the arm.

16. The mechanism according to claim 15, wherein said second pivot is supported by an L-shaped bracket, which is fixed to a shim, and to an internal partition of the profile, at its lower end portion.

17. The mechanism according to claim 10, further comprising means for setting and adjusting the distance of the third rotation axis from the second rotation axis constituted by a flat block, which supports a third pivot, said flat block being arranged so as to perform a translational motion at the end of the second arm, thanks to a through opening which is contoured to be crossed by said end of the lower arm.

18. The mechanism according to claim 17, wherein the position of the block is defined by means of a fixing grub screw, to be screwed into a corresponding threaded hole provided in one side of the block until it affects the through opening and abuts within it against the end.
